(19) United States
(12) Patent Application Publication
(10) Pub. No.: US 2026/0298887 A1
(43) Pub. Date: Oct. 1, 2026

(54) ULTRA-TRACE GAS DETECTION SYSTEM AND METHOD OF USING THE SAME

(71) Applicant: Volatylix, Inc., Cambridge, MA (US)

(72) Inventor: Kenneth A. MARKOSKI, Hudson, MA (US)

(73) Assignee: Volatylix, Inc., Cambridge, MA (US)

(21) Appl. No.: 19/631,862

(22) Filed: Mar. 27, 2026

Related U.S. Application Data
(60) Provisional application No. 63/779,815, filed on Mar. 28, 2025.

(51) Int. Cl. G01N 30/62; B01D 53/02; G01N 30/02; G01N 30/30

(52) U.S. Cl. CPC G01N 30/62; B01D 53/025; G01N 30/30; B01D 2257/708; G01N 2030/025

(57) ABSTRACT

An ultra-trace gas detection system includes: a substrate, a preconcentrator disposed on the substrate, a gas chromatograph coupled to the preconcentrator and disposed on the substrate, and an oscillating field ion spectrometer coupled to the preconcentrator and disposed on the substrate. In some embodiments, the system is a handheld portable device. In some embodiments, the substrate is made of a liquid crystal polymer or a low temperature co-fired ceramic, and the substrate may include one or more of embedded microfluidic channels, embedded gas channels, embedded heaters, and/or embedded electrical circuitry. Ultra-trace gas detection systems and methods according to this disclosure provide greater than 90% sensitivity and specificity with parts per trillion (ppt) detection limits. The disclosed systems and methods can provide early, non-invasive detection of various diseases, such as invasive aspergillosis and various cancers.

### CROSS-REFERENCE TO RELATED APPLICATIONS

This application claims priority to U.S. Provisional Application No. 63/779,815, filed Mar. 28, 2025, the entire disclosure of which is hereby incorporated by reference herein.

### STATEMENT OF FEDERALLY FUNDED RESEARCH

This invention was made with government support under Grant No. 5R44AI141264-04 awarded by DHHS. The government has certain rights in the invention.

### BACKGROUND

The ability to detect and identify different materials including biomarkers of infection and disease, drugs, dangerous chemicals, biological agents, and air pollution has become increasingly more important for safety and wellbeing of human beings. Mass spectrometry, ion mobility spectrometry (IMS), and field asymmetric ion mobility spectrometry (FAIMS) (or DMS) have been used to detect and identify different materials.

Many detection and identification systems include an excessive number of cables, connectors, tubes, and fittings that may contribute to reliability issues over time. The cost, weight and size of the various components (including gas path lengths) can be quite high. In addition to the space requirements for the physical instruments, additional access space for maintenance and servicing is required. Many systems include additional structures (e.g., mounting hardware and thermal zones) that contribute to the overall footprint and maintenance of the instruments.

Accordingly, there is a need in the art for improved detection methods and portable, less expensive material detection and identification methods and devices.

### SUMMARY

One or more embodiments of the disclosure are directed to ultra-trace gas detection systems. The systems include a substrate with a preconcentrator, a gas chromatograph and an oscillating field ion spectrometer. The preconcentrator is disposed on or within the substrate. The gas chromatograph is disposed on or within the substrate and is coupled to the preconcentrator. The oscillating field ion spectrometer is coupled to the gas chromatograph and is disposed on or within the substrate.

Additional embodiments of the disclosure are directed to ultra-trace gas detection devices. The devices include a substrate with one or more microfluidic channels embedded in the substrate. One or more electrical traces are disposed over a surface of the substrate or embedded in the substrate. A preconcentrator is on or within the substrate. The preconcentrator is connected to a sample source through the one or more microfluidic channels embedded in the substrate. A gas chromatograph (GC) is on or within the substrate. The GC is configured to receive a flow of gas from the preconcentrator through the one or more microfluidic channels embedded in the substrate and to separate the sample into components. An oscillating field ion spectrometer is coupled to the GC through the one or more microfluidic channels embedded in the substrate. The oscillating field ion spectrometer is disposed on or within the substrate and is configured to further separate the components from the GC and analyze the further separated components.

Further embodiments of the disclosure are directed to methods of manufacturing ultra-trace gas detection devices. A substrate is formed with one or more microfluidic channels and one or more gas channels embedded therein. One or more electrical traces are formed on or in the substrate. A preconcentrator is formed on or within the substrate. A gas chromatograph and an oscillating field ion spectrometer are formed on or within the substrate.

Some embodiments of the disclosure are directed to methods of detecting a volatile organic compound. A sample of a volatile organic compound to be analyzed is obtained. The sample is concentrated in a preconcentrator. The components of the concentrated sample are separated using a gas chromatograph. The separated components of the sample are detected using an oscillating field ion spectrometer and the volatile organic compounds are identified. The preconcentrator, the gas chromatograph, and the oscillating field ion spectrometer are disposed on or in the same substrate.

Additional embodiments of the disclosure are directed to methods of detecting a disease or infection. A breath sample is obtained from an individual. The sample is concentrated in a preconcentrator. The components of the sample are separated using a gas chromatograph. The separated components of the sample are detected using an oscillating field ion spectrometer. The disease or infection is identified. The preconcentrator, gas chromatograph, and oscillating field ion spectrometer are disposed on the same substrate.

One or more embodiments of the disclosure are directed to ultra-trace gas detection systems including a substrate that has one or more microfluidic channels embedded therein. A preconcentrator is disposed on or within the substrate. An oscillating field ion spectrometer (OFIS) is disposed on or within the substrate and is coupled to the preconcentrator through the one or more microfluidic channels.

Further embodiments of the disclosure are directed to ultra-trace gas detection systems including a substrate that has one or more microfluidic channels embedded therein. A gas chromatograph (GC) is disposed on or within the substrate. An oscillating field ion spectrometer (OFIS) is disposed on or within the substrate and is coupled to the GC through the one or more microfluidic channels.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only embodiments of this disclosure and are therefore not to be considered limiting of its scope, for the disclosure may admit to other equally effective embodiments. Shading included in the appended drawings are for descriptive and visualization purposes only and are not indicative of any particular materials of construction unless otherwise indicated.

FIG. 1A illustrates a method of using an ultra-trace gas detection instrument according to some embodiments of the disclosure.

FIG. 1B illustrates a block diagram of an ultra-trace gas detection device according to one or more embodiments of the disclosure.

FIG. 2 illustrates a perspective view of an ultra-trace gas detection device with battery module, sample collection module and handheld analyzer unit.

FIG. 3 illustrates an ultra-trace gas detection device separated into modules in accordance with one or more embodiments of the disclosure.

FIG. 4 illustrates a block diagram of an ultra-trace gas detection device according to one or more embodiments of the disclosure.

FIG. 5 illustrates a block diagram of an ultra-trace gas detection device with optional configurations according to one or more embodiments of the disclosure.

FIG. 6 illustrates a schematic view of an ultra-trace gas detection device with component mounting schemes for mechanical pneumatic, electrical, and thermal connections according to one or more embodiments of the disclosure.

FIG. 7 illustrates an isometric view of a singular substrate with embedded electronics, batteries, pneumatics and integral components according to one or more embodiments of the disclosure.

FIG. 8 illustrates a section of a substrate with traces, vias, heaters (resistors) and cutouts.

FIG. 9 is a cross-sectional schematic representation of an OFIS device illustrating movement of the ions according to one or more embodiments of the disclosure.

### DETAILED DESCRIPTION

It is to be understood that the following disclosure provides many different embodiments, or examples, for implementing different features of the invention. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “being made of” may mean either “comprising” or “consisting of.” In the present disclosure, a phrase “one of A, B and C” means “A, B and/or C” (A, B, C, A and B, A and C, B and C, or A, B and C), and does not mean one element from A, one element from B and one element from C, unless otherwise described.

The term “about” as used herein means approximately or nearly and in the context of a numerical value or range set forth means a variation of ±15%, or less, of the numerical value. For example, a value differing by ±14%, ±10%, ±5%, ±2%, or ±1%, would satisfy the definition of about.

The use of the terms “a” and “an” and “the” and similar referents in the context of describing the materials and methods discussed herein (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

Embodiments of the present disclosure provide a unique, improved design for an ultra-trace gas detection system that enables size reduction, cost reduction, and reliability improvement. The ultra-trace gas detection systems of the present disclosure provide a handheld device that performs the functions of laboratory instruments.

Embodiments of the disclosure include a portable, handheld ultra-trace gas detection device that can provide critical information quickly to health care providers at the point-of-care (POC). Devices according to some embodiments can provide test results in less than 20 minutes by detecting volatile organic compounds (VOC) in the patient's breath. Ultra-trace gas detection instruments of the present disclosure integrate an oscillating field ion spectrometer (OFIS) with a miniaturized preconcentrator, and a fast gas chromatograph (GC). Configurable software files that run on the platform use the data provided by the OFIS and GC in concert with targeted disease-specific VOC profiles to create diagnostic information for screening, definitive diagnosis, disease staging, treatment monitoring, and monitoring for disease recurrence. As new breath biomarkers are identified, additional configuration files will be added to the platform to expand the instruments applicability.

Ultra-trace gas detection instruments according to embodiments of the disclosure can detect various diseases, such as invasive aspergillosis (IA), mucormycosis, hystoplasmosis, traumatic brain injury (TBI), lung cancer, Clostridioides difficile (C. diff), Parkinson's Disease, other cancers. Detection of IA and lung cancer earlier in the disease state will save lives, reduce overall healthcare costs, reduce patient hospitalization time, reduce the use of invasive and expensive testing and analyses, and reduce the use of broad-spectrum and empirical therapies. Some embodiments of the ultra-trace gas detection instruments can be used to detect other analytes that are detectable using a “chemical nose/tongue” type of platform. For example, other disease states such as diabetic ketoacidosis, public safety concerns such as blood alcohol, illicit drugs, explosive materials, etc.

Ultra-trace gas detection instruments and methods according to various embodiments of the disclosure provide greater than 90% sensitivity and specificity with parts per trillion (ppt) detection limits. Instruments and methods according to one or more embodiments of the disclosure may be non-invasive, provide rapid turnaround time, allow for point-of-care access, and provide a disease-agnostic expandable platform, that does not require specialized training to implement.

Some embodiments of the ultra-trace gas detection instrument allow for reductions in the numbers of cables, connectors, tubes or fittings. Some embodiments advantageously provide detection instruments with improved reliability over time, lower costs, smaller size and weight and shorter gas paths.

One or more embodiments of the present disclosure integrate electrical and pneumatic connections into and onto a singular chemically inert substrate that also serves as a structure to which detector functional components are mounted to with independent thermally controlled zones which may be programmed to optimize performance for use applications.

Some embodiments of the disclosure advantageously provide improved performance; improved reliability and extended system operational life; reduced fabrication, assembly, and maintenance costs; and reduced instrument size that enables handheld-sized instruments. The unique concept utilizes advance fabrication techniques such as using liquid crystal polymers (LCP), low temperature co-fired ceramics (LTCC), three-dimensional (3D) additive printing, or other layered/laminate assembly process to make a single substrate motherboard for a handheld ultra-trace chemical detector from which all the system level detector components are mounted and include microfluidic gas paths, electrical connections, and independent thermal zones. Embodiments of the disclosure eliminate points of failure (e.g., cables, connectors, tubes, fittings) found in conventional devices, thereby greatly increasing system reliability and longevity. Fewer parts may also result in lower cost, reduced size, and reduced weight. In some embodiments, the reduction in the length of the gas path and greater thermal control improves the system performance.

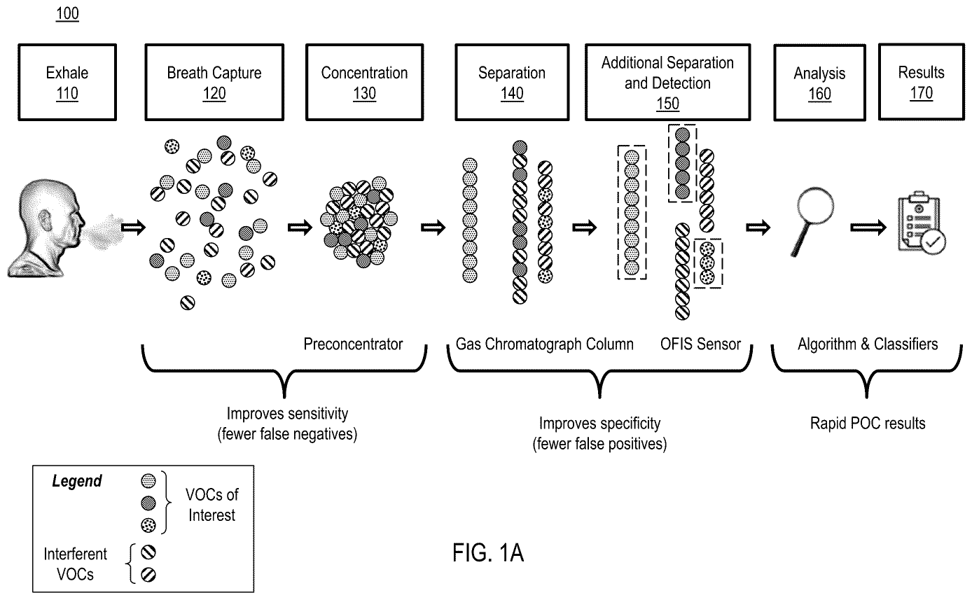

FIG. 1A illustrates the method 100 of using an ultra-trace gas detection instrument according to some embodiments of the disclosure. FIG. 1B illustrates a block diagram of an ultra-trace gas detection device 200 according to one or more embodiments of the disclosure.

At operation 110, a subject (or patient) exhales into a collector inlet of the ultra-trace gas detection instrument. At operation 120, the ultra-trace gas detection device captures the trace molecules from the exhalation sample. For example, using a breath collection module 230, as described herein. At operation 130, the sample is passed through embedded microfluid gas channels 255 disposed on or within a substrate 250 into a preconcentrator 252 component that concentrates the trace molecules for analysis. In some embodiments, the preconcentrator 252 is disposed on the substrate 250 with the embedded microfluid gas channels 255. The use of the breath capture operation 120 and the preconcentrator operation 130 improves the analysis sensitivity, decreasing the occurrences of false negative results.

A preconcentrator 252 is a sample collection/concentration component that collects the analytes from the sample and ejects the analytes into a separation stage. In some embodiments, the preconcentrator 252 includes a membrane coated with a porous material that can selectively and reversibly absorb analytes for analysis while allowing interferents to pass by. In some embodiments, the preconcentrator 252 uses a hollow enclosure coated with a sorbent material. In some embodiments, the preconcentrator 252 uses a stainless steel tube packed or coated with a suitable sorbent material. The sorbent material of some embodiments includes packed granules (single or multi-bed) constrained by components (e.g. screen, glass wool) within the tube or sorbent material coated on the inner walls. In some embodiments, the preconcentrator 252 is wrapped in a conductive wire to allow for rapid and controllable resistive heating. The membrane or sorbent material can be rapidly heated using electrical current to desorb the analytes. In some embodiments, the preconcentrator 252 increases the concentration of the analytes of interest by an amount greater than or equal to 10×, 25×, 50× or 100×.

The concentrated sample is passed through a gas chromatograph (GC) 254 at operation 140 that separates the sample based on one or more chemical properties of the analytes within the sample. In some embodiments, the sample moves between the preconcentrator 252 and the GC 254 using the embedded microfluid gas channels 255. Molecular properties used for GC separation include, but are not limited to, polarity, molecular weight or intermolecular forces. The GC 254 of some embodiments is disposed on the substrate 250 with the preconcentrator 252.

The separated sample is then passed through an ion spectrometer (OFIS 900) at operation 150. In some embodiments, the sample moves between the GC 254 and the OFIS 900 using the embedded microfluid gas channels 255. The ion spectrometer further separates the analyte molecules from the sample. The combination of GC and ion spectrometry increases the specificity of the analysis, decreasing the occurrences of false positive results. In some embodiments, the OFIS 900 is disposed on the same substrate 250 as the preconcentrator 252, the GC 254 and the embedded microfluid gas channels 255. In some embodiments, the ultra-trace gas detection system 200 includes embedded microfluid gas channels 255 configured to act as a recirculation system 285. In some embodiments, the recirculation system 285 includes a filter 290 to trap or remove impurities within the recirculated fluids. The filter 290 of some embodiments is accessible to the user and is a replaceable consumable component.

At operation 160, an analyzer 258 of the ultra-trace gas detection device analyzes the volatile organic compounds of interest from the separated sample. Analysis can be performed, for example, by comparison of properties (e.g., dispersion plots, the change in mobility coefficient (a), the mass-to-charge ratios (m/z)) of the analyte measured at the ion spectrometer with known compounds. At operation 170, the analysis results are presented in a suitable manner to the operator. For example, the analysis results can be presented on a computer monitor, a tablet screen, an integrated screen, a cell phone screen, or printed.

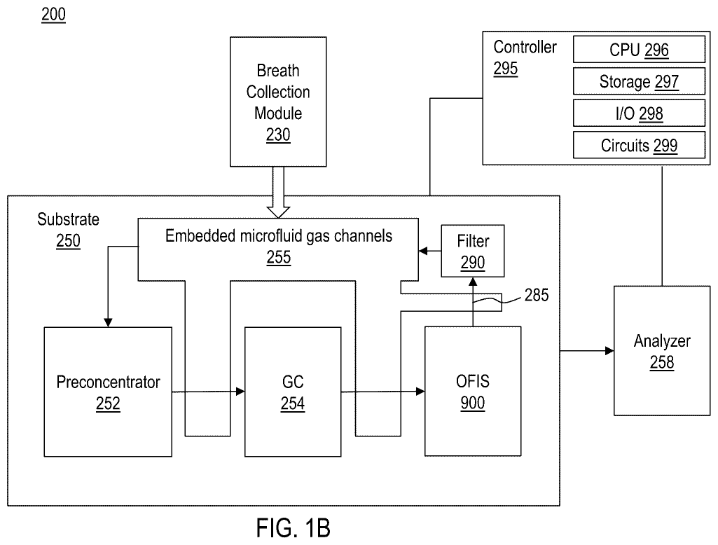

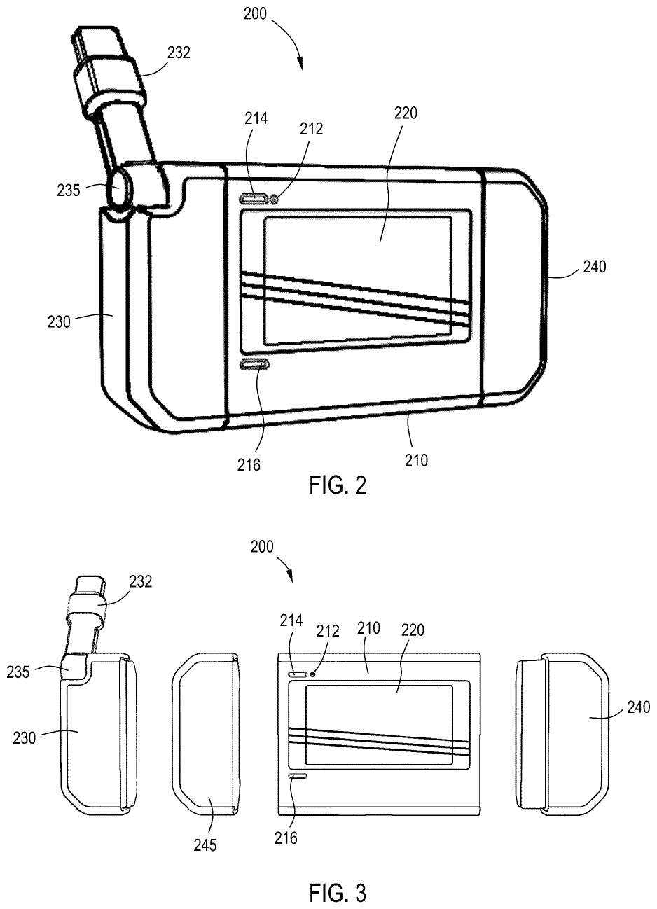

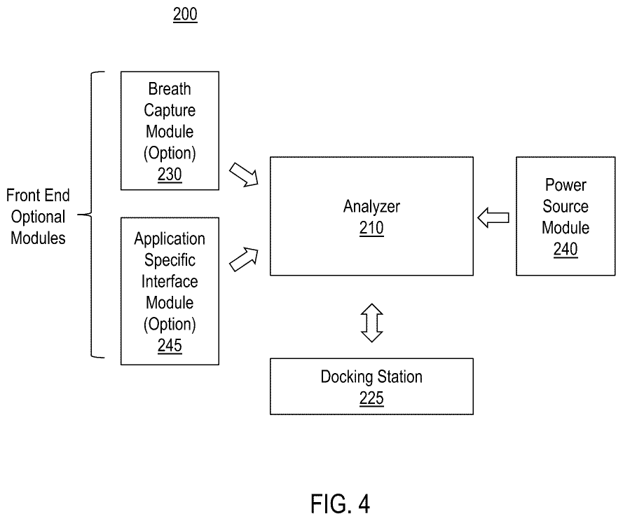

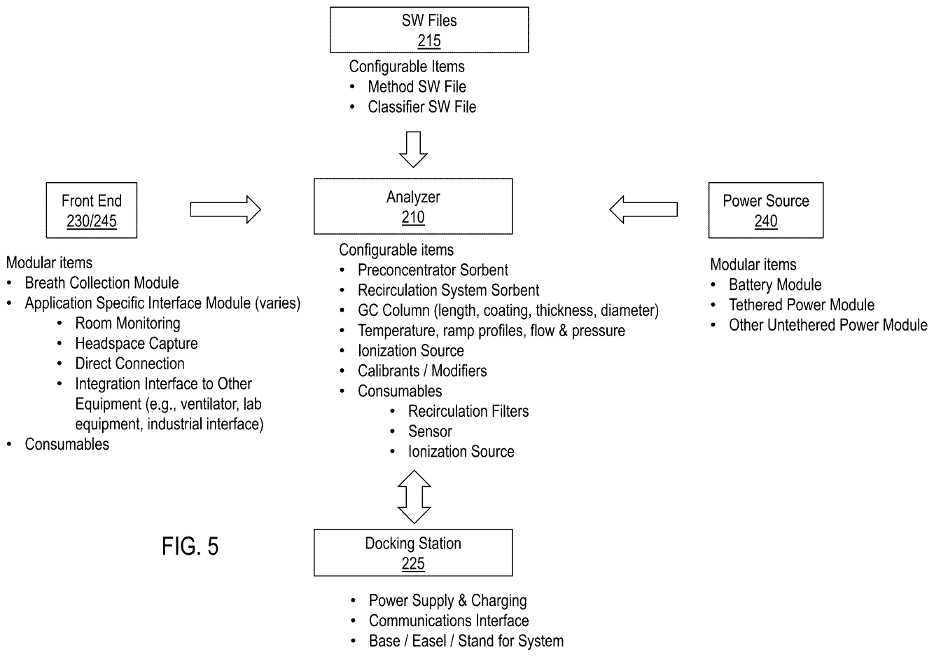

Conventional ultra-trace gas detection systems are desktop or bench mounted systems with large footprints. Even known portable ultra-trace gas detection systems can have dimensions of about 10″ to about 11″ in length, about 6″ to about 8″ in width, and about 4.5″ to about 5.2″ in depth, not including the battery, sample collection components, the user interface, and include more than 80 tubes, fittings, cables, and connectors. Such devices are not handheld devices. On the other hand, ultra-trace gas detection systems, according to embodiments of the present disclosure, are much thinner and may be handheld. In some embodiments, such a device has dimensions of about 10″ to about 11.5″ in length, about 5″ to about 6″ in width, and about 2.5″ to about 3″ in depth. An example of such a device has dimensions of about 11.4″ in length, about 5.7″ in width, and about 2.8″ in depth, which includes the battery, sample collection port, and the user interface. FIG. 2 illustrates a perspective view of an ultra-trace gas detection device 200 with a battery module, a sample collection module and a handheld analyzer unit 210. according to one or more embodiments of the disclosure. FIG. 3 illustrates an ultra-trace gas detection device 200 separated into modules in accordance with one or more embodiments of the disclosure. FIG. 4 illustrates a block diagram of an ultra-trace gas detection device 200 according to one or more embodiments of the disclosure. FIG. 5 illustrates a block diagram of an ultra-trace gas detection device 200 with optional configurations according to one or more embodiments of the disclosure.

With reference to FIGS. 2-5, some embodiments of the ultra-trace gas detection device 200 include a handheld analyzer unit 210 with a screen 220. The screen 220 can be any suitable device that can be used to present information including, but not limited to, passive or active matrix screens, capacitive touch screens, 7-segment displays, ePaper displays, and light emitting diodes (LEDs). In some embodiments, the screen 220 can be a cell phone.

The illustrated ultra-trace gas detection device 200 includes a power button 212, an activation button 214 and a mode button 216. The various buttons can be positioned in any suitable location on the ultra-trace gas detection device 200. In some embodiments, there are more or less than three buttons accessible to the user or administrator. In some embodiments, the buttons are replaced with a touch screen providing virtual buttons to access the features of the ultra-trace gas detection device 200.

In some embodiments, the ultra-trace gas detection system 200 includes a docking station 225. The docking station 225 functions as a power supply & charging station in some embodiments. The docking station 225 may also function as a communications interface in some embodiments, and as base, easel, or stand in some embodiments. The docking station 225 of some embodiments provides a safe storage location for the ultra-trace gas detection device 200 when not in active use that may also function to maintain a sufficient charge for continued operation.

The ultra-trace gas detection device 200 of some embodiments includes a breath collection module 230 with a mouthpiece 232. The mouthpiece 232 is connected to the breath collection module 230 with an adjustable hinge 235. The mouthpiece 232 can be made of any suitable material and has an opening in the end to allow a subject to exhale into the ultra-trace gas detection device 200. The mouthpiece 232 of some embodiments is covered with a consumable component (e.g., a replaceable cover piece) to ensure that the device is acceptable for use by more than one subject. In some embodiments, the mouthpiece 232 is a replaceable consumable component. In some embodiments, the mouthpiece 232 or mouthpiece covering contains a material that serves as a calibrant, or quality assurance (QA) baseline confidence check to confirm that the system is performing to specification with each use.

The ultra-trace gas detection device 200 of some embodiments includes a power source module 240 connected to the handheld analyzer unit 210. The power source module 240 can be configured, for example, as a battery module that can include rechargeable or non-rechargeable batteries, a tethered power module, or some other untethered power module.

The ultra-trace gas detection system 200 includes modular items in various embodiments. The modular items are those that through a simple module exchange (usually performed by the operator) can extend the usable period or change the application function of the system. Some items may be “hot swapped” where the system continues to function while the exchange is performed.

The breath collection module 230 of some embodiments is a modular component that can be removed from the handheld analyzer unit 210 and replaced with application specific interface modules 245. FIG. 3 illustrates the breath collection module 230 separated from the handheld analyzer unit 210 and an alternate application specific interface module 245. The application specific interface module 245 of some embodiments include application specific interface modules. Exemplary application specific interface modules 245 include, but are not limited to, modules configured to monitor environment or room conditions, modules configured for headspace capture (for liquids or solids), direct connection modules for network connections, and integration interfaces for external equipment (e.g., ventilator, lab equipment, industrial interface).

Configurable items of the ultra-trace gas detection system 200 are those that through a simple component/subassembly swap (without platform redesign) or programmable parameter (performed by factory or field personnel) can change/optimize system performance for a different use case application (some parameters may be altered within a test run). For example, changing the front end component for different application specific interface modules 245.

Software (SW) 215 files may be called upon by the operator to perform different or expanded scope testing. SW 215 includes, but are not limited to, software configured to perform the physical analysis, controlling parameters, actuators, circuits, etc., within the ultra-trace gas detection device 200 to pass the sample through the preconcentrator 252, the GC 254 and the OFIS 900. SW 215 may also include databases or analysis algorithms to analyze the results of the sample and produce human readable results.

The analyzer 210 includes the substrate 250 with the preconcentrator 252, GC 254 and OFIS 900 disposed thereon. The components of the analyzer may be configurable (e.g., modular or changeable). The configurable components include, but are not limited to, the sorbent used for the preconcentrator 252, the GC column parameters (e.g., length, coating, thickness, diameter), temperature and temperature ramping profiles, flow rates, gas pressure, the ionization source for the OFIS, additives used for internal calibration, modifiers for improved analysis, filters and sensors. The relation of the modular items and the configurable items of the modular ultra-trace gas detection system 200 according to various embodiments is shown in FIG. 5.

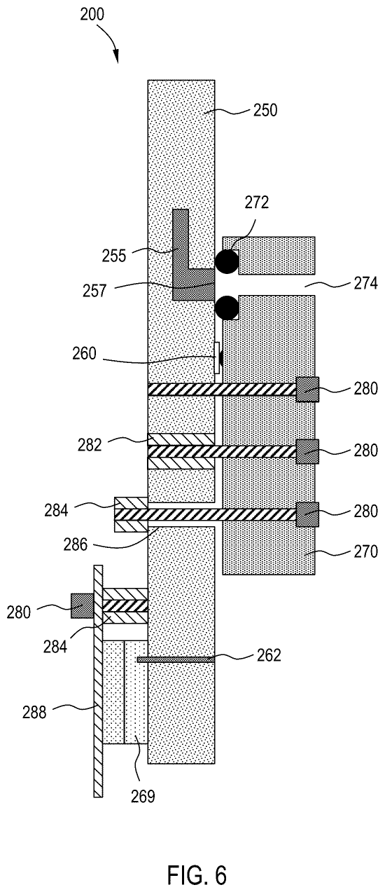

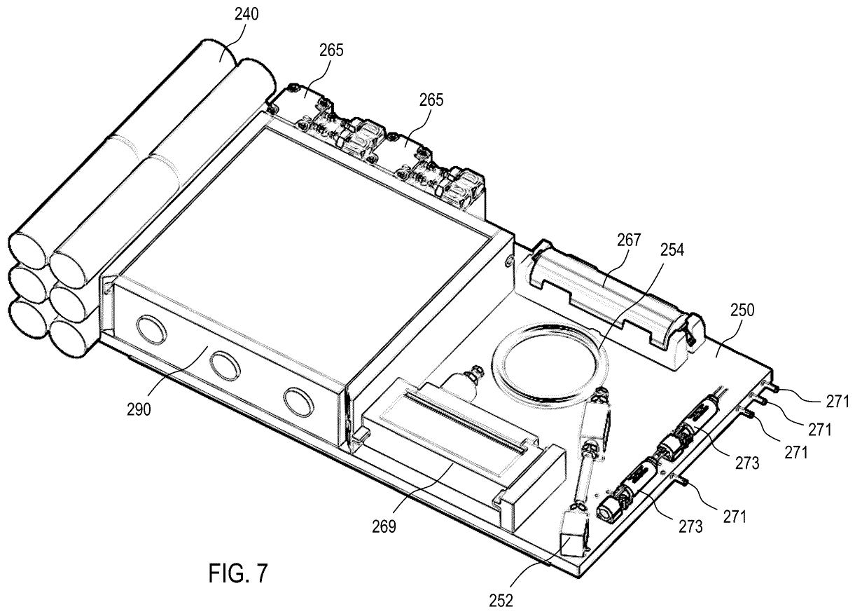

FIG. 6 illustrates a schematic view of an ultra-trace gas detection device 200 with component mounting schemes for mechanical, pneumatic, electrical, and thermal connections according to one or more embodiments of the disclosure. Some embodiments of an ultra-trace gas detection device 200 include a singular substrate 250 with embedded electronics and pneumatics and integral components mounted to it. FIG. 7 illustrates an isometric view of a singular substrate 250 with embedded electronics, batteries, pneumatics and integral components according to one or more embodiments of the disclosure. In some embodiments, the substrate 250 is made of a liquid crystal polymer, but the substrate material is not limited to liquid crystal polymers.

With reference to FIGS. 6 and 7, the single substrate 250 of some embodiments of the ultra-trace gas detection device 200 allows for a simplified, efficient fabrication process. The singular substrate 250 of some embodiments is a high electrical performance substrate material that is chemically resistant. The singular substrate 250 of some embodiments includes embedded microfluids gas channels 255 with a gas channel opening 257 in the substrate 250. In some embodiments, the singular substrate 250 includes at least one of an integrated component mounting, gas path routing, electrical connections, electrical circuitry or thermal zones. The ultra-trace gas detection device 200 with singular substrate 250 of some embodiments advantageously eliminates cables, connectors, gas path tubing and fittings. The ultra-trace gas detection device 200 of some embodiments has improved performance with reduced gas path distances and reduced potential for leaks.

In some embodiments, the singular substrate 250 is fabricated in layers (similar to a printed circuit board) which incorporates embedded electrical traces 260, vias 262, heaters, and pneumatic channels for gas path routing. In some embodiments, device components (e.g., pumps 265, valves 273, heaters, batteries or capacitors 267, fans, sensors, indicators, etc.) are mounted directly to the substrate 250. In some embodiments, contact pads, leaf springs, pogo pins, etc., on the components create electrical and/or communications connections to surface electrical pads on the substrate 250. The embodiment illustrated in FIG. 7 includes a replaceable OFIS sensor housing 269. The replaceable OFIS sensor can be removed/replaced from the housing by side or bottom mount slides (e.g., like a drawer). Some embodiments include a replaceable filter 290 configured as a replaceable filter cartridge. The illustrated embodiment includes a battery pack which may be part of the power source module 240. In some embodiments, electrical circuitry and routings are incorporated on or in the substrate. In some embodiments, interconnection to additional circuit boards and/or components 270 are incorporated using headers/connectors. In one or more embodiments, O-rings 272, gaskets, etc., incorporated with the components 270 create gas tight seals for the gas path to the substrate's internal microfluidic channels 257 through pneumatic vias 274. In some embodiments, external connections 271 (e.g., protruding tube ports or holes from the substrate surface or edges to the internal microfluidic gas paths) are used for gas connections to external components (e.g., front end modules like a breath collection module).

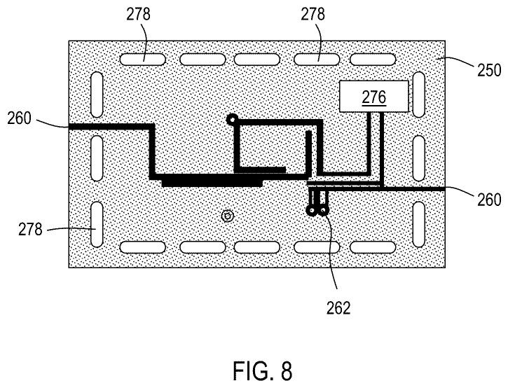

In some embodiments, heaters are incorporated on the surface or within the layers of the substrate creating heated zones and/or paths. In one or more embodiments, voids or cutouts create air gapped islands that may be used to isolate thermally and shield electronically different zones yet still provide gas and electrical pathways to and from components. For example, FIG. 8 illustrates a substrate 250 with traces 260, vias 262, heaters (resistor 276) and cutouts 278. Embedded or surface heaters (e.g., resistor 276), coupled with voids 278 in the substrate 250 provide thermal gaps, creating separate thermal zones or islands for thermal management in some embodiments. The substrate continues to provide structure and pathways for electrical connections and microfluidic channels in between the thermal gaps.

Components can be fastened or clipped to the substrate 250. In some embodiments, fasteners or clips into or through the substrate enable easy mounting and replacement of components. Alignment features in the substrate and/or components facilitate proper gas and electrical connections. FIG. 6 illustrates three alternate, non-limiting connections between the components 270 and singular substrate 250 using threaded fasteners 280. The top fastener 280 is threaded directly into the substrate 250. The middle fastener is threaded into an insert 282 in the substrate 250. The bottom fastener is threaded into a standoff 284 through an opening 286 in the substrate 250. Only one, or any combination, of the connections may be used in various embodiments of the ultra-trace gas detection device 200. The embodiment of FIG. 6 includes a PCB 288 connected to the singular substrate 250 using a fastener 280 threaded into the standoff 284 on the substrate. The PCB 288 is electrically connected to the substrate 250 using headers 269. The connection of components to the substrate (gas path, electrical, and physical mounting) is done without fittings and tubes, cables, and connectors. As shown in FIG. 6, there are numerous ways (only a few options are shown) to provide electrical contacts, gas path routing, and physical mounting methods for components.

Embodiments of the disclosure include an oscillating field ion spectrometry (OFIS) device but are not limited to OFIS devices. Identifying different materials with oscillating field ion spectrometry (OFIS) has increased usefulness because OFIS devices, compared to mass spectrometers, are smaller, portable, less expensive to procure and operate, less complex, use significantly less power, and do not require a high vacuum to operate. OFIS devices according to embodiments of the present disclosure provide greater detection sensitivity by increased ion transmission efficiency without compromising specificity. OFIS devices according to embodiments of the disclosure have improved performance, including a reduction in false negatives and false positives than FAIMS devices. OFIS devices according to embodiments of the disclosure avoid the reduction in sensitivity due to micro-deposits and surface charging in the analytical channel that occurs in FAIMS devices. Fabrication and testing of OFIS devices according embodiments of the disclosure is simpler and less expensive than FAIMS devices. In some embodiments, OFIS devices have an expanded operational temperature range than FAIMS devices. Further, OFIS devices according to various embodiments of the disclosure are replaceable. When the sensitivity of the OFIS system falls below a threshold level, the OFIS device can be quickly and economically replaced. Ion transfer efficiency losses, gas path leaks, and higher assembly costs of FAIMS devices are reduced or eliminated in OFIS devices according to embodiments of the disclosure. OFIS devices according to embodiments of the disclosure provide ultra-trace (e.g., less than 1 parts-per-million (ppm)) detection and identification of chemical vapors of interest. In some embodiments, the OFIS devices are capable to measuring analytes in the parts-per-billion (ppb) and parts-per-trillion (ppt) ranges.

In an integrated OFIS device, first, second, and third segments (or regions) are arranged in a line next to each other. The first region is an ionization segment where the material vapor that is being identified along with a carrier gas flows through the ionization segment. The ionization segment includes a plasma generating region that generates plasma from the gas that flows through the ionization segment. The plasma generating region generates ions from the material vapor and the carrier gas. Other ions may be generated in the plasma generating region including modifier ions, fragmented ions, ambient ions, contaminant ions, and ions of additional materials that may be present in the sample. In some embodiments, a portion of the material vapor and a portion of the carrier gas is ionized and a remaining portion of the sampled material and the carrier gas is not ionized. The second region is a filtering segment that is located next to the ionization segment along a direction of flow of the carrier gas. In some embodiments, the carrier gas carries the ions from the ionization segment to the filtering segment. The third region is a detection segment that is located next to the filtering segment along a direction of the carrier gas flow. In some embodiments, the carrier gas carries the ions from the filtering segment to the detection segment. In some embodiments, all the gases and vapors, including the carrier gas, a modifier gas, and the material vapors exit the OFIS device from the detection segment. In some embodiments, the first, second, and third segments make up a single channel through the ionization segment, the filtering segment, and the detection segment.

The filtering segment includes two parallel electrodes on opposing walls of the filtering segment that are parallel to the direction of the flow the carrier gas, e.g., on top and bottom walls or on opposing sidewalls. The two electrodes are connected to a voltage source that provides opposite polarity DC voltages to the two electrodes. The two electrodes are additionally connected to a radio frequency (RF) voltage source that provides an RF oscillating voltage in addition to the DC voltage to the two electrodes. When the carrier gas carries the ions from the material vapor between the two electrodes, the positive and negative ions experience forces by the electric fields generated by the DC and RF voltages between the two electrodes and move in opposing directions as the RF voltage changes from positive to negative. In some embodiments, the combination of the opposite polarity DC voltages and the RF oscillating voltage causes unwanted ions, such as the carrier gas ions or ions of materials other than the ions of the material vapor, to reach the two parallel electrodes of the filtering segment and get discharged while the carrier gas and material vapor ions are passing by the parallel electrodes. Thus, some of the ions are removed, e.g., filtered from the flowing carrier gas to provide filtered material vapor. In some embodiments, the ions of the material vapor, are undischarged as they flow from the filtering segment to the detection segment. In some embodiments, the unwanted ions include the ions of contaminants that have entered the ionization segment or the ions of the material forming the ionization segment.

The detection segment includes two parallel electrodes on opposing walls of the detection segment that are parallel to the direction of the flow of the carrier gas, e.g., on top and bottom walls or on opposing sidewalls, similar to the parallel electrodes of the filtering segment. The two electrodes are connected to a voltage source that provides DC voltages to the two electrodes of the detection segment. In some embodiments, DC voltages of opposite polarity are applied to the opposing parallel electrodes. The two parallel electrodes of the detection segment are additionally connected to a detection system that detects, e.g., registers or counts, the number of ions that impact the two parallel electrodes of the detection segment and get discharged. In some embodiments, the detection system is a charge detector. In some embodiments, the positive ions are discharged by one of the two parallel electrodes and the negative ions are discharged by the other electrode of the two parallel electrodes of the detection segment and the detection system detects the number of positive and negative ions, e.g., based on the number of ions registered and discharged by the two electrodes. Ions of additional unidentified materials may be detected. The detection information of the unidentified materials may be stored in a memory of the OFIS system for subsequent identification and analysis if desired.

In some embodiments, the DC voltages of the two electrodes of the detection segment, the DC voltages of the two electrodes of the filtering segment, the RF voltages and the RF frequency applied between the two electrodes of the filtering segment are adjusted based on the mobility of the ions of the material vapor and the mobility of the unwanted ions, such as the carrier gas ions. The RF voltage and the DC voltage of the filtering segment are selected to optimize sensitivity and selectivity of the OFIS device. For example, higher RF voltage provides increased separation of the ions, thereby increasing selectivity. However, increasing the RF voltage may reduce the sensitivity. The adjustment of the RF and DC voltages cause a portion of the unwanted ions to be discharged, e.g., to be removed, in the filtering segment and a remaining portion of unwanted ions along with wanted ions, unknown ions, and neutrals to pass by the parallel electrodes of the detection segment. As discussed above, in filtering the unwanted ions, the ions are discharged in the filtering segment and, thus, are not detected by the detection system in the detection segment, although, the discharged ions are carried by the carrier gas.

In some embodiments, the OFIS device operates in continuous ion processing mode with a single pair of planar electrodes. Since drift flow transports the ions, both positive and negative ion analysis may occur simultaneously.

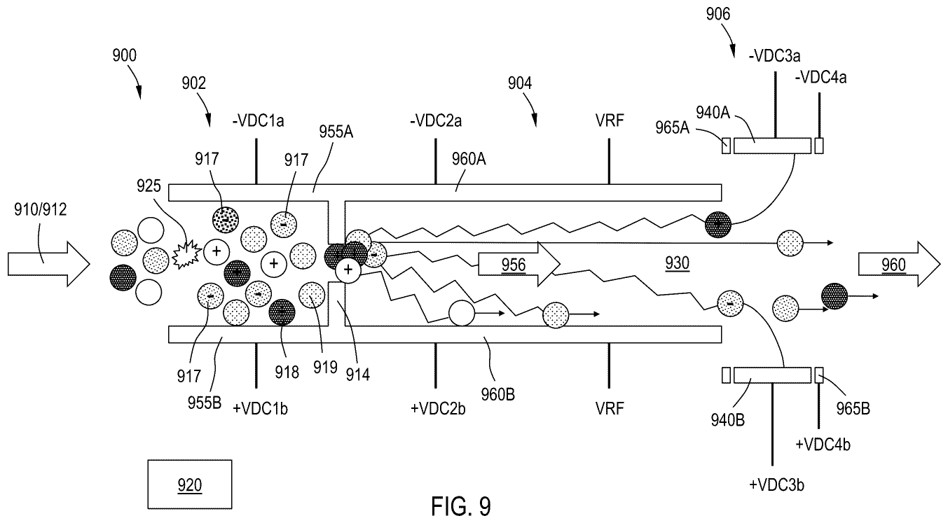

FIG. 9 is a cross-sectional schematic representation of an OFIS device 900 illustrating movement of the ions according to one or more embodiments of the disclosure. The carrier gas flow 910 and the material vapor flow 912 are mixed in the ionization segment 902 and pass through the ionizing tool 925. The ionizing tool 925 generates positive ions 918 and negative ions 917 and produces the gas flow 956 that passes through the filtering segment channel 930. Thus, the gas flow 956 includes the positive ions 918, negative ions 917, and neutral atoms/molecules 919.

During operation, DC voltages are applied to the ionization region electrodes 955A, 955B in the ionization region. A negative DC voltage −VDC1a is applied to the top electrode 955A and a positive DC voltage +VDC1b is applied to the bottom electrode 955B by the voltage source 920 in some embodiments. In other embodiments, the positive voltage is applied to the top electrode 955A and the negative voltage is applied to the bottom electrode 955B. In some embodiments, the applied voltages +VDC1a and −VDC1b range from about −20 V to about +20 V, while in other embodiments, the applied voltages range from about −10 V to about 10 V. In some embodiments, the applied voltages to the top electrode 955A and bottom electrode 955B are the same polarity and/or 0V. In some embodiments, a jet entry is included, as illustrated by the narrowed opening at the interface 914 between the ionization segment 902 and the filtering segment 904.

During operation, DC voltages are applied to the parallel filter electrodes 960A, 960B in the filtering segment. A negative DC voltage −VDC2a is applied to the top electrode 960A and a positive DC voltage +VDC2b is applied to the bottom electrode 960B by a voltage source in some embodiments. In other embodiments the positive voltage is applied to the top electrode 960A and the negative voltage is applied to the bottom electrode 960B. In addition, an RF voltage VRF is applied between the top electrode 960A and the bottom electrode 960B. The combination of the DC and the RF voltages cause some of the ions to get discharged by contacting the electrodes 960A, 960B in the filtering segment 904 and some negative ions and positive ions exit the filtering segment 904 and enter the detection segment 906. Although, one ion is shown contacting each of the detector electrodes 940A, 940B, a plurality of ions contacts the detector electrodes 940A, 940B in some embodiments. In some embodiments, the applied voltages +VDC2a and −VDC2b range from about −45 V to about +20 V, while in other embodiments the applied voltages range from about −40 V to about +15 V.

During operation, a negative DC voltage −VDC3a is applied to the top detector electrode 940A and a positive DC voltage +VDC3b is applied to the bottom detector electrode 940B by a voltage source in some embodiments. In other embodiments, the positive voltage is applied to the top electrode 940A and the negative voltage is applied to the bottom electrode 940B. The application of the voltages −VDC3a and +VDC3b cause the positive and negative ions to be discharged, e.g., detected, by the respective top detector electrode 940A and the bottom detector electrode 940B. As shown, the discharged ions leave the detection segment as part of the exhaust gas flow 960 through an opening at the end of detection segment 906. In some embodiments, the voltages applied to the detector electrodes 940A, 940B ranges from about −20 volts to about +20 volts with the detector electrodes 940A and 940B having opposite polarities, while in other embodiments, the voltages −VDC3a and +VDC3b range from about −10 V to about +10 V. During operation, DC voltages are applied to ion guidance electrodes 965A, 965B during operation to guide the ions to the detector electrodes 940A, 940B. A negative DC voltage −VDC4a is applied to the top ion guidance electrode 965A and a positive DC voltage +VDC4b is applied to the bottom ion guidance electrode 965B by the voltage source 920 in some embodiments. In other embodiments, the positive voltage is applied to the top electrode 965A and the negative voltage is applied to the bottom electrode 965B. In some embodiments, the applied voltages +VDC4a and −VDC4b range from about −20 V to about +20 V, while in other embodiments the applied voltages range from about −10 V to about 10 V. In some embodiments, the voltage applied to the top ion guidance electrode 965A and the bottom ion guidance electrode 965B are about the same as the corresponding top and bottom detector electrodes 940A, 940B.

In some embodiments, −VDC2a or −VDC3a ranges between about −3 volts to about −15 volts and +VDC2b or +VDC3b ranges from about 3 volts to about 15 volts. In other embodiments −VDC2a or −VDC3a ranges from about −4.7 to about −12.5 volts and +VDC2a or +VDC3a ranges from about 4.7 volts to about 12.5 volts. In some embodiments, −VDC2a is applied to the top electrode 960A and +VDC2b is applied to the bottom electrode 960B, while +VDC3a is applied to the top detector electrode 940A and −VDC3a is applied to the bottom detector electrode 940B. In some embodiments, +VDC2b is applied to the top electrode 960A and −VDC2a is applied to the bottom electrode 960B, while +VDC3b is applied to the top detector electrode 940A and −VDC3a is applied to the bottom detector electrode 940B. In some embodiments, 0 V is applied to top electrode 960A or the bottom electrode 960B and a positive or negative voltage is applied to the other electrode.

In some embodiments, the flow of the ions depends on the charge of the ions and the mobility of the ions, and the voltages applied to the top electrode 960A and the bottom electrode 960B. In some embodiments, the ion flow is programmed and controlled by a control system. Higher flow may provide higher sensitivity in some embodiments, and higher DC voltage applied to the filter electrodes 960A, 960B may provide improved ion filtering.

While an OFIS is described above, the present disclosure is not limited to OFIS devices. The present disclosure is applicable to any trace gas detection technology or configuration. For example, embodiments of the present disclosure are applicable to various medical diagnostics. Examples of medical diagnostic applications within the scope of this disclosure includes: cancer detection, staging, treatment failure, and screening for lung cancer, breast cancer, pancreatic cancer, and any other cancer that produces markers that can be detected by trace gas analysis; infectious disease diagnosis, including fungal, bacterial, viral pneumonia, lower respiratory tract infection, and any other infectious disease that produces markers that can be detected by trace gas analysis; and neurologic disorder diagnosis, including traumatic brain injury (TBI), dementia, and any other disorder that produces markers than can be detected by trace gas analysis. Examples of various other trace gas detection applications include, but are not limited to, food processing, aroma detection, fragrance detection/identification, and air quality monitoring, toxic gas detection, drug detection, alcohol detection, explosives, chemical warfare agents, toxic industrial chemicals (TICs), toxic industrial materials (TIMs), chemical leak detection, gas purity determination, fenceline monitoring, health and human safety monitoring, etc.

Strong intensity asymmetric electric field waveform and DC compensation voltage are applied between two parallel electrodes (i.e., the OFIS 900 filter region) through which the ions pass in a substantially continuous manner by gas flow rate. Because the ions'movement along the analytical gap axis is carried out by transport gas flow rate, the OFIS sensor provides the possibility to generate ion spectra for both polarity species simultaneously, without switching DC electric field.

The oscillated electric field waveform (F~), which may be about 1 MHz to about 2 MHz, typically has a short time duration at a high field portion of the waveform and then a longer time at a low field duration at an opposite polarity. The duration of the high field and low field portions are applied such that the net voltage (average voltage for one full period) being applied to the OFIS filter electrodes is zero. Transport gas flow drags both polarity ions through a narrow analytical gap. Only specific combinations of RF and DC voltages provide the possibility to pass the targeted ion species through the analytical gap and then can be recorded on one of the positive or negative ion detectors in some embodiments. Ions that are not compounds of interest for the application (clutter) are allowed to contact the walls of the analytic channel thereby neutralizing the ions allowing them to pass by the detectors undetected. The sensor therefore operates as a tunable ion filter.

The OFIS system is discussed in greater detail in U.S. Patent Application Publication No. 2024/0234116 to Markoski et al., which is incorporated herein by reference in its entirety.

In some embodiments, the ultra-trace gas detection device 200 omits the preconcentrator 252. With reference to FIG. 1B, in embodiments of this sort, the sample passes directly from the mouthpiece 232 to the GC 254 through the embedded microfluid gas channels 255. In some embodiments, the ultra-trace gas detection device 200 omits the GC 254 so that the sample passes directly from the preconcentrator 252 to the OFIS 900. In some embodiments, the OFIS 900 is replaced with a different separation component, or with a different analyzer. In some embodiments, the ultra-trace detection device 200 omits the preconcentrator 252 and the GC 254 so that the sample passes directly from the mouthpiece 232 to the OFIS sensor 900 through the embedded microfluidic channels gas 255.

Some embodiments of the substrate 250 advantageously facilitate modular benchtop assembly, debugging, and testing independent or additional structures and packaging. In conventional devices, multiple housings are required to mount all the various components and numerous electrical and gas path connections are needed to achieve functionality. The singular substrate architecture of some embodiments facilitates single assembly swap for quick field replacement and improved uptime.

LCP and LTCC processes are fabrication processes that are constructed of layers of materials that are fused together using temperature and pressure to create a singular device (similar to printed circuit board (PCB) fabrication). Because of the independent layers, electrical traces, vias, embedded components, and channels, voids, etc. may be integrated into the design. LCP and LTCC, unlike PCB materials, may operate at high temperatures greater than about 200 °C with extremely low outgassing and geometrical expansion/contraction making them suitable materials and processes for ultra-trace chemical detection. Similarly, 3D additive fabrication builds up layers and components to complete the device. In some embodiments, the fabrication process uses glass, fiberglass, or other materials to contain the embedded components, channels, embedded components, electrical traces, etc.

Referring back to FIG. 1B, some embodiments of the disclosure include a controller 295, also referred to as a control module. The controller 295 is configured to operate the various components of the ultra-trace gas detection device 200. The controller 295 can include a general-purpose computing device including a processor 296 and a non-transitory computer-readable storage medium 297. The non-transitory computer-readable storage medium 297 may be encoded with, e.g., store, computer program code 298 such as executable instructions. Execution of the instructions by the processor 296 provides (at least in part) a design tool that implements a portion of or all of the functions of the ultra-trace gas detection device 200, such as controlling actuators or valves to cause fluid flow and receiving data from the various components. Some components of the controller may be external to the ultra-trace gas detection device 200. For example, external network elements and input/output components.

The processor 296 is electrically coupled to the non-transitory computer-readable storage medium 297 by a bus and to an input/output (I/O) interface 298 by the bus. A network interface may also be electrically connected to the processor 296 by the bus. The network interface of some embodiments is connected to a network, so that the processor 196 and non-transitory computer-readable storage medium 297 can connect to external elements using the network. In some embodiments, the processor 296 is a central processing unit (CPU), a multi-processor, a distributed processing system, an application specific integrated circuit (ASIC), a System-on-Chip (SOC; e.g., an ESP32 device), and/or a suitable processing unit.

In some embodiments, the non-transitory computer-readable storage medium 297 is an electronic, magnetic, optical, electromagnetic, infrared, and/or semiconductor system or apparatus or device. For example, the non-transitory computer-readable storage medium 297 can include a semiconductor or solid-state memory, a magnetic tape, a removable computer diskette, a random-access memory (RAM), a read-only memory (ROM), a rigid magnetic disk, and/or an optical disk.

In some embodiments, the controller 295 includes an I/O interface 298, which is coupled to external circuitry 299. In some embodiments, the I/O interface 298 may include a keyboard, a keypad, a mouse, a trackball, a trackpad, a touchscreen, and/or cursor direction keys for communicating information and commands to the processor 296.

The network interface is coupled to the processor 296 and allows the controller 295 to communicate with the network, to which one or more other computer systems are connected. The network interface can include: wireless network interfaces such as BLUETOOTH, WIFI, WIMAX, GPRS, or WCDMA; or wired network interfaces such as ETHERNET, USB, or IEEE-1364.

In some embodiments, the controller 295 is configured to receive information through the I/O interface 298. The information received through the I/O interface 298 includes one or more of instructions, data, design rules, libraries of components and cells, or other parameters for processing by the processor 296.

In some embodiments, the controller 295 is configured to operate one or more valves and pumps to move the sample through the embedded microfluid gas channels 255, the preconcentrator 252, the GC 254, and the OFIS 900. In some embodiments, the controller 295 is configured to analyze data provided by one or more of the preconcentrator 252, the GC 254, or the OFIS 900. In some embodiments, the controller 295 and the analyzer 258 are configured as a single component. In some embodiments, the analyzer 258 and the controller 295 are the same component.

In some embodiments, the controller 295 or analyzer 258 is configured with one or more algorithms to compare the results from the GC 254 or OFIS 900 with predetermined analysis criteria. For example, the algorithm may allow for the comparison of the OFIS 900 results with a database of known compounds. In some embodiments, the algorithm includes an artificial intelligence (AI) or machine learning (ML) component that allows the ultra-trace gas detection device 200 to be reconfigured automatically based on usage information and environmental parameters. For example, a set of calibration data or a calibration sample may be used to determine baseline operational parameters. The AI/ML component can update the baseline operational parameters based on the routine usage of the ultra-trace gas detection device 200.

By embedding microfluidic channels routing the gas path to/from devices/ports in the substrate, external tubes and fittings may be eliminated reducing the potential for leaks. Thus, eliminating the size, weight, cost, and required accessibility for the tubes and fittings.

By embedding traces and/or including surface traces, embodiments of the disclosure reduce the number of cables and connectors from greater than about 40 in conventional devices down to just a few (fewer than about 10 or fewer than about 5). This reduces a prominent source of reliability issues (short circuits or open circuits) while reducing the size, weight, and cost, of the overall device. It also increases packaging density (reducing system size) by eliminating the required accessibility for electrical connections. Circuitry may also be contained on or embedded within the substrate eliminating the need for additional PCBs. In some embodiments, the circuitry is on the surface of the substrate. In some embodiments, the circuitry is embedded within the substrate. In some embodiments, the circuitry is in multiple layers which are independently on the surface of the substrate or within the substrate. In some embodiments, one or more vias electrically connect circuitry between layers or surfaces of the substrate with other layers or surfaces.

By embedding the microfluidic channels in the substrate, disclosed embodiments reduce the number of tubes and fittings from greater than about 40 in conventional devices down to fewer than about 10 or fewer than about 5. This reduces a prominent source of reliability issues (leaks) while reducing the size, weight, and cost, of the overall device. It also increases packaging density (reducing system size) by eliminating the required accessibility for gas connections. Connecting tubes into the board may serve as ports for external connections in some embodiments.

The substrate 250 of some embodiments serves as a motherboard in which all operational components for the ultra-trace detection function are included in or on the substrate. This allows the working system to function outside of its structure and packaging allowing full accessibility for assembly, debugging, and repair.

In some embodiments, embedded gas paths are accompanied by embedded heaters to better control the temperature profile of the entire gas path in some embodiments. Gas paths may be shorter thereby reducing the potential for contamination and “cold spots”. Elimination of fittings reduces a leading source of reliability issues (leaks) in some embodiments.

The higher electrical and pneumatic packaging density, elimination of numerous components, reduced weight, and elimination of the mounting structure facilitates device level packaging in a handheld form, which is not obtained using conventional electronics, pneumatic packaging materials, and methods.

Since the substrate incorporates all the core functional elements of the ultra-trace chemical detector, the entire substrate with its components may be easily removed and replaced in the field.

Contamination, such as outgassing, from materials is a challenge in the design of ultra-trace chemical detection systems. Heat is often required to prevent condensation and cold spots within the gas path. Added heat amplifies the release of contaminant. For this reason, stainless steel fittings, Viton O-rings, Teflon, stainless steel, or polyether ether ketone (PEEK) tubes, and PEEK, stainless steel, or glass treated metals may be used for manifolds, but the manifold materials are not limited to these materials. Other suitable materials are included within the scope of this disclosure. Conventional printed circuit board materials used as a laminate substrate may not be chemically inert and therefore may contribute significant interferent signatures to the chemical analysis. Applied heat would exacerbate the situation. LCP and LTCC are two materials used as printed circuit board substitutes and/or for the fabrication of custom devices primarily for electrical performance reasons and chemical resistance in food and medical device applications. Embodiments of this disclosure uniquely combine the disclosed materials, electrical trace configurations, and microfluidic configuration into a singular device.

It will be understood that not all advantages have been necessarily discussed herein, no particular advantage is required for all embodiments or examples, and other embodiments or examples may offer different advantages.

Embodiment 1. An ultra-trace gas detection system, comprising: a substrate; a preconcentrator disposed on or within the substrate; a gas chromatograph coupled to the preconcentrator and disposed on or within the substrate; and an oscillating field ion spectrometer coupled to the gas chromatograph and disposed on or within the substrate.

Embodiment 2. The ultra-trace gas detection system of embodiment 1, wherein the substrate is made of a liquid crystal polymer or a low temperature co-fired ceramic.

Embodiment 3. The ultra-trace gas detection system of embodiment 1 or 2, wherein the system is a handheld portable device.

Embodiment 4. The ultra-trace gas detection system of any of embodiments 1 to 3, further comprising one or more microfluidic channels embedded in the substrate.

Embodiment 5. The ultra-trace gas detection system of any of embodiments 1 to 4, further comprising electrical circuitry disposed on or embedded in the substrate.

Embodiment 6. The ultra-trace gas detection system of embodiment 5, wherein the electrical circuitry includes electrical traces.

Embodiment 7. The ultra-trace gas detection system of any of embodiments 1 to 6, further comprising one or more gas channels embedded in the substrate.

Embodiment 8. The ultra-trace gas detection system of any of embodiments 1 to 7, wherein the substrate includes one or more thermal gaps formed therein.

Embodiment 9. The ultra-trace gas detection system of any of embodiments 1 to 8, further comprising one or more heaters disposed on or embedded in the substrate.

Embodiment 10. The ultra-trace gas detection system of any of embodiments 1 to 9, further comprising a battery disposed on the substrate.

Embodiment 11. An ultra-trace gas detection device comprising: a substrate comprising: one or more microfluidic channels embedded in the substrate; one or more electrical traces disposed over a surface or embedded in the substrate; a preconcentrator on or within the substrate, the preconcentrator connected to a sample source through the one or more microfluidic channels embedded in the substrate; a gas chromatograph (GC) on or within the substrate, the GC configured to receive a flow of gas from the preconcentrator through the one or more microfluidic channels embedded in the substrate and to separate the sample into components; and an oscillating field ion spectrometer coupled to the gas chromatograph through the one or more microfluidic channels embedded in the substrate and disposed on or within the substrate, the oscillating field ion spectrometer configured to further separate the components from the GC and analyze the further separated components.

Embodiment 12. The ultra-trace gas detection device of embodiment 11, wherein the substrate is made of a liquid crystal polymer or a low temperature co-fired ceramic.

Embodiment 13. The ultra-trace gas detection device of embodiment 11 or 12, further comprising one or more heaters disposed on or embedded in the substrate.

Embodiment 14. The ultra-trace gas detection device of any of embodiments 11 to 13, wherein the substrate includes one or more thermal gaps formed therein.

Embodiment 15. A method of manufacturing an ultra-trace gas detection device, comprising: forming a substrate including one or more microfluidic channels and one or more gas channels embedded therein; forming one or more electrical traces on or in the substrate; forming a preconcentrator on the substrate; forming a gas chromatograph on the substrate; and forming an oscillating field ion spectrometer on the substrate.

Embodiment 16. The method according to embodiment 15, further comprising forming one or more heaters embedded in or on the substrate.

Embodiment 17. The method according to embodiment 15 or 16, wherein the forming the substrate includes performing a three-dimensional printing operation.

Embodiment 18. The method according to any of embodiments 15 to 17, wherein the substrate is made of a liquid crystal polymer or a low temperature co-fired ceramic.

Embodiment 19. A method of detecting a volatile organic compound, comprising: obtaining a sample of a volatile organic compound to be analyzed; concentrating the sample in a preconcentrator; separating components of the concentrated sample using a gas chromatograph; detecting the separated components of the sample using an oscillating field ion spectrometer; and identifying the volatile organic compound, wherein the preconcentrator, the gas chromatograph, and the oscillating field ion spectrometer are disposed on or within a same substrate.

Embodiment 20. The method according to embodiment 19, wherein the preconcentrator, gas chromatograph, and oscillating field ion spectrometer are disposed on a same surface of the substrate.

Embodiment 21. The method according to embodiment 19 or claim 20, wherein the obtaining a sample includes capturing a breath from an individual.

Embodiment 22. The method according to embodiment 21, wherein the volatile organic compound is generated by a disease or an infection of the individual.

Embodiment 23. The method according to embodiment 22, wherein the disease or infection is a pneumonia, including a viral, a bacterial, and a fungal pneumonia.

Embodiment 24. The method according to embodiment 22, wherein the disease or infection is invasive aspergillosis.

Embodiment 25. The method according to embodiment 22, wherein the disease or infection is a cancer.

Embodiment 26. The method according to embodiment 25, wherein the disease or infection is lung cancer, breast cancer, or pancreatic cancer.

Embodiment 27. A method of detecting a disease or infection, comprising: obtaining a breath sample from an individual; concentrating the sample in a preconcentrator; separating components of the concentrated sample using a gas chromatograph; detecting the separated components of the sample using an oscillating field ion spectrometer; and identifying the disease or infection, wherein the preconcentrator, gas chromatograph, and oscillating field ion spectrometer are disposed on or within a same substrate.

Embodiment 28. The method according to embodiment 27, wherein circuitry, including a memory, is disposed on the substrate.

Embodiment 29. The method according to embodiment 28, wherein the disease or infection is identified by comparing data obtained from the oscillating field ion spectrometer with data stored in the memory.

Embodiment 30. The method according to any of embodiments 27 to 29, wherein the preconcentrator, gas chromatograph, and oscillating field ion spectrometer are disposed on a same surface of the substrate.

Embodiment 31. The method according to any of embodiments 27 to 30, wherein the disease or infection is a pneumonia.

Embodiment 32. The method according to any of embodiments 27 to 31, wherein the disease or infection is invasive aspergillosis.

Embodiment 33. The method according to any of embodiments 27 to 30, wherein the disease or infection is a cancer.

Embodiment 34. The method according to any of embodiments 27 to 33, wherein the disease or infection is lung cancer.

Embodiment 35. An ultra-trace gas detection system, comprising: a substrate having one or more microfluidic channels embedded therein; a preconcentrator disposed on or within the substrate; and an oscillating field ion spectrometer (OFIS) disposed on or within the substrate and coupled to the preconcentrator through the one or more microfluidic channels.

Embodiment 36. An ultra-trace gas detection system, comprising: a substrate having one or more microfluidic channels embedded therein; gas chromatograph (GC) disposed on or within the substrate; and an oscillating field ion spectrometer (OFIS) disposed on or within the substrate and coupled to the GC through the one or more microfluidic channels.

Embodiment 37. The ultra-trace gas detection system of embodiment 35 or 36, wherein the substrate is made of a liquid crystal polymer or a low temperature co-fired ceramic.

Embodiment 38. The ultra-trace gas detection system of any of embodiments 35 to 37, wherein the system is a handheld portable device.

Embodiment 39. The ultra-trace gas detection system of any of embodiments 35 to 38, further comprising electrical circuitry disposed on or embedded in the substrate.

Embodiment 40. The ultra-trace gas detection system of embodiment 39, wherein the electrical circuitry includes electrical traces.

Embodiment 41. The ultra-trace gas detection system of any of embodiments 35 to 40, wherein the substrate includes one or more thermal gaps formed therein.

Embodiment 42. The ultra-trace gas detection system of any of embodiments 35 to 41, further comprising one or more heaters disposed on or embedded in the substrate.

Embodiment 43. The ultra-trace gas detection system of any of embodiments 35 to 42, further comprising a battery disposed on the substrate.

Embodiment 44. The ultra-trace gas detection system of any of embodiments 35, or 37 to 43, further comprising a gas chromatograph (GC) on the substrate between and coupled to the preconcentrator and the OFIS through the embedded microfluidic channels.

Embodiment 45. The ultra-trace gas detection system of any of embodiments 36 to 43, further comprising a preconcentrator disposed on the substrate before and coupled to the GC and the OFIS through the embedded microfluidic channels.

Reference throughout this specification to “one embodiment,” “certain embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein has been described with reference to particular embodiments, those skilled in the art will understand that the embodiments described are merely illustrative of the principles and applications of the present disclosure. It will be apparent to those skilled in the art that various modifications and variations can be made to the method and apparatus of the present disclosure without departing from the spirit and scope of the disclosure. Thus, the present disclosure can include modifications and variations that are within the scope of the appended claims and their equivalents.

What is claimed is:

1. An ultra-trace gas detection system, comprising:
a substrate;
a preconcentrator disposed on or within the substrate;
a gas chromatograph coupled to the preconcentrator and disposed on or within the substrate; and
an oscillating field ion spectrometer coupled to the gas chromatograph and disposed on or within the substrate.

2. The ultra-trace gas detection system of claim 1, wherein the substrate is made of a liquid crystal polymer or a low temperature co-fired ceramic.

3. The ultra-trace gas detection system of claim 1, wherein the system is a handheld portable device.

4. The ultra-trace gas detection system of claim 1, further comprising one or more microfluidic channels embedded in the substrate.

5. The ultra-trace gas detection system of claim 1, further comprising electrical circuitry disposed on or embedded in the substrate.

6. The ultra-trace gas detection system of claim 5, wherein the electrical circuitry includes electrical traces.

7. The ultra-trace gas detection system of claim 1, further comprising one or more gas channels embedded in the substrate.

8. The ultra-trace gas detection system of claim 1, wherein the substrate includes one or more thermal gaps formed therein.

9. The ultra-trace gas detection system of claim 1, further comprising one or more heaters disposed on or embedded in the substrate.

10. The ultra-trace gas detection system of claim 1, further comprising a battery disposed on the substrate.

11. An ultra-trace gas detection device comprising:
a substrate comprising:
one or more microfluidic channels embedded in the substrate;
one or more electrical traces disposed over a surface or embedded in the substrate;
a preconcentrator on or in the substrate, the preconcentrator connected to a sample source through the one or more microfluidic channels embedded in the substrate;
a gas chromatograph (GC) on or in the substrate, the GC configured to receive a flow of gas from the preconcentrator through the one or more microfluidic channels embedded in the substrate and to separate the sample into components; and
an oscillating field ion spectrometer coupled to the gas chromatograph through the one or more microfluidic channels embedded in the substrate and disposed on or in the substrate, the oscillating field ion spectrometer configured to further separate the components from the GC and analyze the further separated components.

12. The ultra-trace gas detection device of claim 11, wherein the substrate is made of a liquid crystal polymer or a low temperature co-fired ceramic.

13. The ultra-trace gas detection device of claim 11, further comprising one or more heaters disposed on or embedded in the substrate.

14. The ultra-trace gas detection device of any of claims 11, wherein the substrate includes one or more thermal gaps formed therein.

15. A method of detecting a volatile organic compound, comprising:
obtaining a sample of a volatile organic compound to be analyzed;
concentrating the sample in a preconcentrator;
separating components of the concentrated sample using a gas chromatograph (GC);
further separating and detecting the GC separated components of the sample using an oscillating field ion spectrometer; and
identifying the volatile organic compound,
wherein the preconcentrator, the gas chromatograph, and the oscillating field ion spectrometer are disposed on or within a same substrate.

16. The method according to claim 15, wherein the preconcentrator, gas chromatograph, and oscillating field ion spectrometer are disposed on a same surface of the substrate.

17. The method according to claim 15, wherein the obtaining a sample includes capturing a breath from an individual.

18. The method according to claim 17, wherein the volatile organic compound is generated by a disease or an infection of the individual.

19. The method according to claim 18, wherein the disease or infection is a viral pneumonia, a bacterial pneumonia, a fungal pneumonia, or a cancer.

20. The method according to claim 18, wherein the disease or infection is invasive aspergillosis.
